(19) United States
(12) Patent Application Publication
(10) Pub. No.: US 2005/0038708 A1
(43) Pub. Date: Feb. 17, 2005

(54) Consuming Web Services on Demand

(75) Inventor: Lisa Wu, Cliffside Park, NJ (US)

Correspondence Address: GMORPHER INC., P.O Box 9, FORT LEE, NJ, 07024, US

(73) Assignee: GMORPHER INCORPORATED, Pt Jefferson Station, NY (US)

(21) Appl. No.: 10/604,681

(22) Filed: Aug. 10, 2003

(51) Int. Cl. G06F 17/60

(52) U.S. Cl. 705/26

(57) ABSTRACT

A method, system, and computer program product of consuming Web Services on demand, the present invention takes WSDL as the initial input; spontaneously and concurrently invokes Web Services with transparent code generations and dynamic configurations; processes the invocation result and charges end users with pay-as-you-go and prepaid finance schedules.

### BACKGROUND OF INVENTION

1. Field of the Invention

The present invention is about consuming Web Services with instantaneous inputs, dynamic reconfiguration, transparent code generation, and multiple threads.

2. Related Art

Service Oriented Architecture (SOA) renders computer software as on-demand services. SOA is evolving into a pervasive enterprise computing platform because it affords more flexibility and efficiency in enterprise application integration than the traditional component architecture like EJB and COM.

Grid computing is a configuration, implementation, and exhibit of SOA. On-demand computing is the delivery of the computer grid. Web Services is the content and service delivered by on-demand computing under SOA, which comprises of following major characteristics: 1. Input to the grid is instantaneous and spontaneous; 2. Grid wide parameters can be configured and reconfigured in real time; 3. The grid adopts a pay-as-you-go finance schedule.

Web Services Description Language (WSDL) is the cookbook for Web Services. Residing in the computer networks, WSDL is an XML file to describe Web Services. WSDL consists of two main parts, interface and implementation.

The interface part comprises of abstract descriptions of: 1. binding, specifying the network transport, such as SOAP, HTTP, SNMP, etc., to deliver described Web services; 2. portType, listing the operations of the described Web services; 3. types, defining the SOAP schema types of the input and output parameters for the operations.

Pointing to the actual service implementations, the implementation part contains one or more ports. Each port has an endpoint, network address where the described Web service resides. Each port points to a binding instance in the interface part.

Simple Object Access Protocol (SOAP) is stacked on top of HTTP and XML. HTTP is the network transport for SOAP while XML is the content format of SOAP messages. SOAP is designed for remote method invocations by means of XML plain text messaging. SOAP is the most widely used messaging mechanism for Web Services.

Technologies bound for Web Services fall into three categories:
1. Creating Web Services. It is a server technology that exposes existing or new software constructs as services by creating WSDL files for the services.
2. Deploying and managing Web Services. It is a middle tier to server technology that involves UDDI registries and network configurations. See following US patent application Ser. Nos.: a) 20030055878, 20030055868, and 20030055624 byjames Fletcher et al; b) 20020178254, 20020178244, and 20020178214 by Peter Brittenham et al.
3. Consuming Web Services. It is a client technology that invokes the services based on information provided by the WSDL files.

As the title has suggested, the present invention is about consuming Web Services. The US patent application titled “Invocation of Web Service from a Database” (Ser. No. 20030093436 by Larry Brown et al) invokes Web Services with carefully constructed SQL queries. It's an attempt to solve the client problem with a server side approach. The present invention invokes Web Services with client software constructs that are independent of database management systems. The US patent application titled “Testing Web Services as Components” (number 20030074423 by Thomas Mayberry et al) is an attempt to treat Web Services as software constructs under component architecture for testing purposes. The present invention itself follows SOA and takes a SOA approach throughout the Web Services testing process.

By adopting SOA and by making the process of consuming Web Services totally coding free from user's perspective, the present invention instantly making Web Services accessible via the Web and is readily configurable as a Web Services tester as well.

### The System Configuration

A round trip of consuming Web Services involves steps of: 1. constructing SOAP request messages; 2. sending SOAP request messages via computer networks; 3. processing SOAP request messages; 4. invoking methods; 5. constructing SOAP response messages; 6. sending SOAP response messages via computer networks; 7. processing SOAP response messages.

Steps 1, 2, and 7 are client side operations; steps 3, 4, 5, and 6 server side operations. The present invention covers the client side operations that has a full spectrum of suboperations. The present invention focuses on: interacting with end users with a Web browser; constructing invocation request objects from user data; making SOAP calls; and processing SOAP responses.

In the early stage of Internet, most of the Web pages are static HTML pages. Powered by the demand of dynamic content, Web page constructs like Microsoft's Active Server Page (ASP) and Sun Microsystems's Java Server Page (JSP) become the industry standards for dynamic pages. JSP is used by the computer program product because of its support for pure Java programming. The computer program product comprises of a set of JSP files that render HTML pages with real time data. The computer program product utilizes Apache Tomcat as the Servlet engine to run these JSP pages.

In the middle tier is a set of servlets deployed in Tomcat to direct the data traffic between the Web browser and the Java backend, which transforms user data like WSDL and concurrency configurations into Java objects. Meanwhile, the computer program product calls Axis api to generate Java client stubs from WSDL such that network programming reduces to a local task. The computer program product constructs the invocation request object from user data and makes SOAP calls by invoking methods in the client stubs, which makes a client counterpart of the round trip server step 4.

When making SOAP calls the generated client stubs talk to Axis runtime, which serializes the Java objects into SOAP request messages and sends SOAP request messages over computer networks. Upon receipt of SOAP responses, AXIS deserializes them into Java objects and the computer program product processes the Java objects and present the result with JSP pages.

### SUMMARY OF INVENTION

The present invention provides steps and means for on-demand coding-free service invocations by constructing invocation objects on the fly. The present invention is also completely end user coding free for multi-threading, for processing SOAP responses, and for measuring SOAP performance.

The conventional wisdom for on-demand invocations is to use DII Dynamic Invocation Interface, where steps of generating client stubs are skipped. While DII handles simple SOAP data types at ease, it encounters great difficulties in constructing invocation inputs for complex data types. More over, manual coding is needed with DII in order to construct the invocation object. The present invention provides steps and means for automatically constructing invocation inputs with the generated client stubs up to an arbitrary complexity of input data types.

The present invention is configured as a Web Services tester when setting the number of invocation threads or the number of invocations per thread to be greater than one. The tester measures and presents SOAP performance in real time interaction with end users.

By adopting SOA, the present invention innovates in depth and width as embodied in: 1. cloning prior Web Services invocations; 2. processing overloaded methods; 3. dynamically reconfiguring Web Services by intercepting, transforming, and redirecting SOAP messages; 4. providing pay-as-you-go and prepaid finance schedules; 5. dynamically reconfiguring the list of operations to be invoked given a Web service; 6. instantly making Web Services accessible via the Web.

### BRIEF DESCRIPTION OF DRAWINGS

FIG. 1 depicts an embodiment of the present invention that takes WSDL as an initial input and produces an invocation result as the output.

FIG. 2 depicts a generic workflow of the present invention.

FIG. 3 depicts the control flow of parsing a WSDL file.

FIG. 4 depicts the control flow of constructing a Web Services invocation object.

FIG. 5 depicts the control flow of constructing invocation inputs.

FIG. 6 depicts the workflow of invoking a Web service with multiple threads.

FIG. 7 depicts the control flow of cloning a prior Web Services invocation.

FIG. 8 depicts the control flow of charging the end users.

### DETAILED DESCRIPTION

The present invention is directed to a system, method, and computer program product for on-demand invocation of Web Services with multiple threads. The system functions as a computing grid in computer networks where it spontaneously processes concurrent Web Services invocation requests. For each invocation request, the system spurs one or more threads to invoke the Web service designated by the request. Then, the system presents the invocation result including SOAP performance as automatically generated JSP pages.

### An Overview of the Present Invention

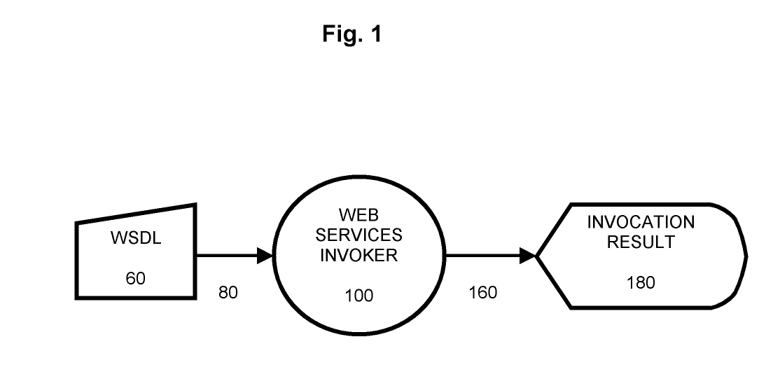

The present invention hides all the complexity of invoking Web Services from end users. As depicted in FIG. 1, the initial input 60 to the system is the location of a WSDL file. Web Services invoker 100 retrieves WSDL from computer network 80, transparently invokes Web Services described in the WSDL, and present the invocation result 180 via the computer network 160. Input to the system is instantaneous and spontaneous. The system is interactive with end users, but under no circumstances manual coding of end users is needed for the present invention to carry out Web Services invocations.

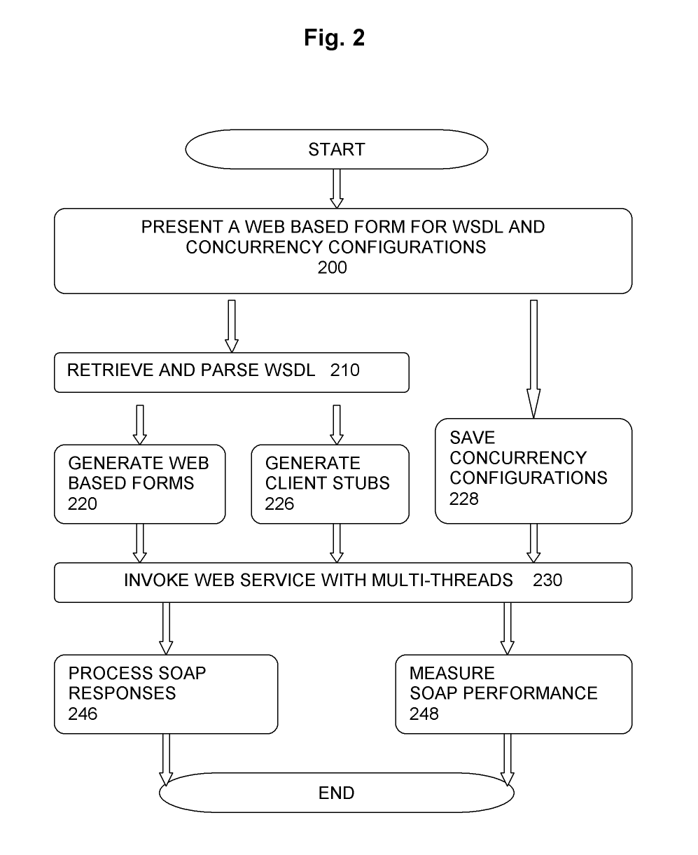

FIG. 2 offers a close view of how the present invention works in real world. First, the system presents a Web based form 200 to the end user. WSDL location is the required form field; concurrency configurations are optional from end user's perspective, which means the system assigns default values in the absence of user inputs. Second, the system simultaneously retrieves and parses the WSDL 210, and saves the concurrency configurations 228. Third, as a result of parsing, the system simultaneously generates Web based forms 220 and client stubs 226. Fourth, the Web Services invoker 230 takes the form data, generated client stubs, and configurations and invokes the designated Web Services with multiple threads. Fifth, the system simultaneously processes SOAP responses 246 and measures SOAP performance 248.

### The Construction Phase

Prerequisites for invoking a Web service are: 1. Concurrency configurations that dictate the multi-threading behavior of the service invoker; 2. An invocation object that makes SOAP calls; 3. Invocation inputs that carry the parameter values of operations.

Concurrency configurations, either from user inputs or from system default values, consists of following entries: 1. The number of threads to be spurred for service invocation; 2. The initial number of threads to be spurred; 3. The time interval for the next thread upon the initial number of threads being spurred; 4. The number of repeated invocations for each invocation thread.

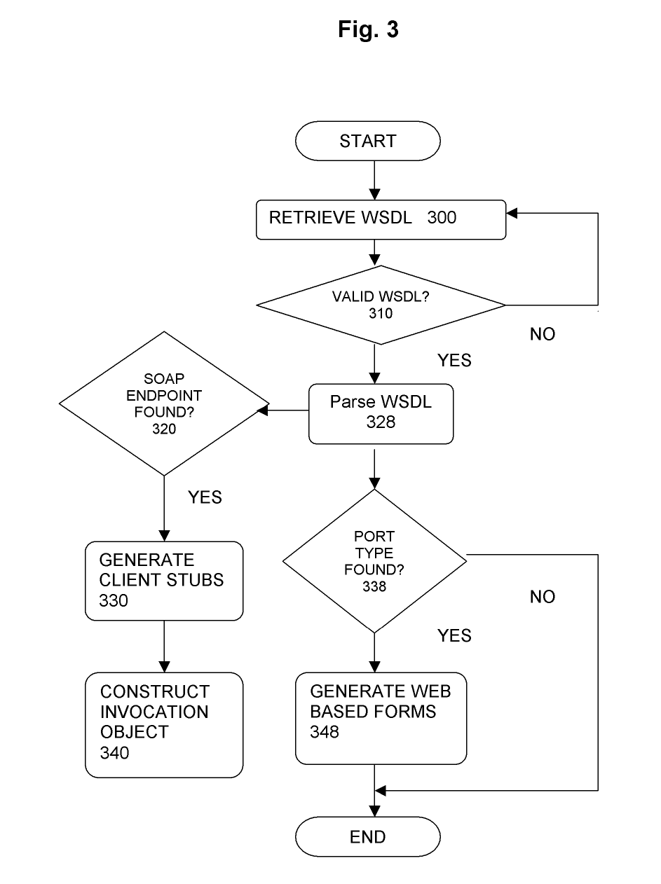

The present invention provides steps and means for transparently constructing the invocation object and inputs, which are preceded by parsing the WSDL file as depicted in FIG. 3. When the WSDL 300 is retrieved and validated in process 310, the system parses the XML content of WSDL 328. Then, the system runs two independent tests on SOAP endpoint 320 and port type 338. If SOAP endpoint is found, the system generates client stubs 330, and constructs invocation object 340. If port type is found, the system generates Web based forms 348.

Web based forms and client stubs are simultaneously generated for performance reasons. While end users are filling the forms with parameter values, the system is generating client stubs and constructing the invocation object in the background. When the form data is submitted and inputs are constructed, the system is ready to invoke the designated Web service and the end user will not experience noticeable latency in SOAP response.

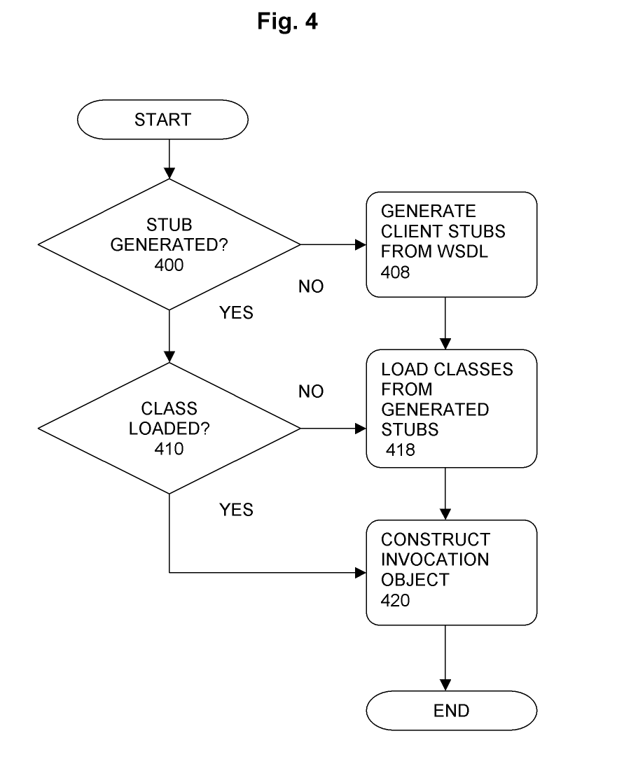

FIG. 4 provides a close view of how the invocation object is constructed. First, the system generates client stubs 408 from WSDL. Second, the system loads classes 418 from the generated stubs. Third, the system constructs the invocation object 420 from loaded classes. The system also offers shortcuts to the construction of invocation object provided that client stubs 400 and/or loaded classes 410 preexist. These shortcuts are designed for improving system performance because invocation object construction is a resource intensive operation.

FIG. 4 actually shows three routes to constructing an invocation object: 1. starting with WSDL, taking 400 408 418 420; 2. starting with the generated stubs, taking 400 410 418 420; 3. starting with the loaded classes, taking 400 410 420.

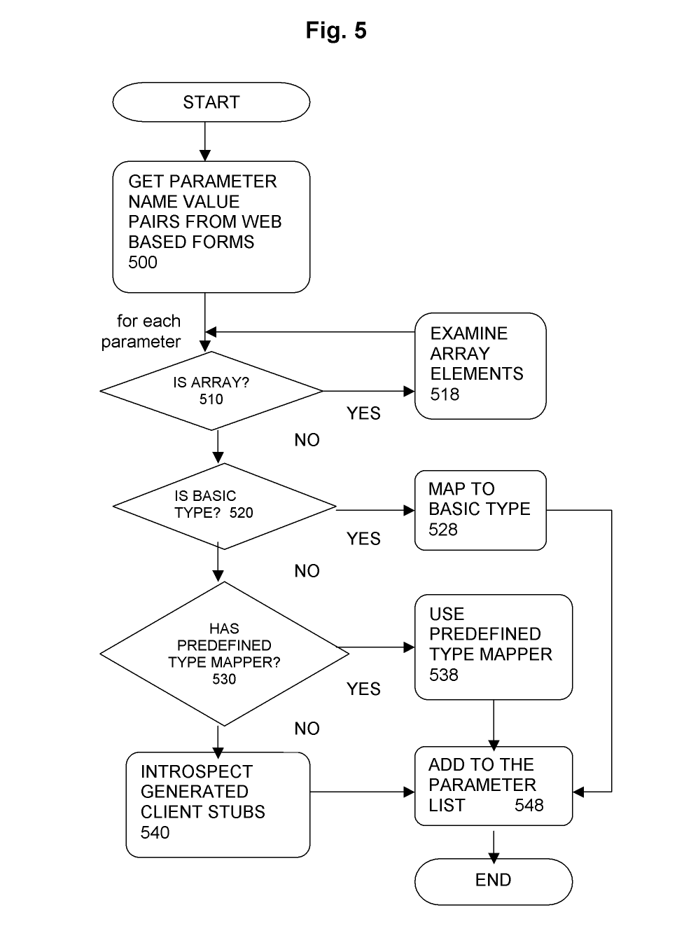

FIG. 5 extends process 348 in FIG. 3 and provides a close view of constructing invocation inputs. The system parses the form data 500 and maps SOAP schema data types to those of underlying programming language. The computer program product aspect of the present invention maps SOAP types to Java types. The system runs a series of tests. The first one is an array test 510, if true, recursively testing whether it″s an array of arrays. Otherwise, the system tests whether the SOAP type can be mapped to a basic type 520 for the underlying programming language; if true, mapping it to the basic type 528 and adding the parameter to the parameter list 548. Otherwise, the system tries to use predefined typemappers 530 and 538. Finally, the system introspects the generated client stubs 540 and maps to the types defined in the generated stubs.

FIG. 5 depicts a parameter-by-parameter loop of constructing the invocation inputs. Here is the topology of Web Services: a WSDL file describes one or more Web services; each Web service has one or more operations; and

each operation consists of zero or more parameters.

Therefore, FIG. 5 is for a certain operation in a certain Web service described by a certain WSDL.

### The Invocation Phase

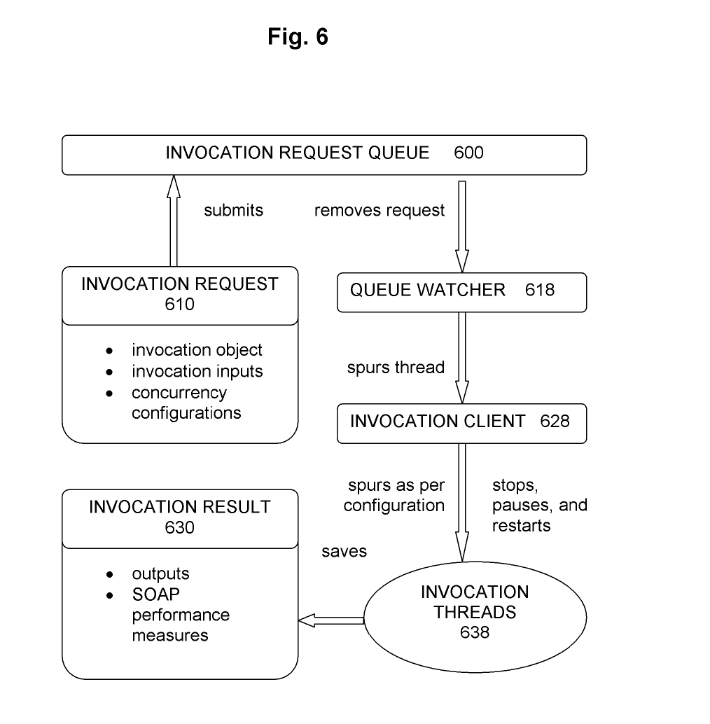

The system packages the above-mentioned prerequisites into an invocation request object 610 as depicted in FIG. 6. Then the system submits the invocation request to the invocation queue 600. A daemon thread called queue watcher 618 removes the request from the queue and spurs a client thread 628 for each request in the queue. Please note that the system processes concurrent submissions of WSDL and form data from end users. For each user submission, concurrency configurations are saved; invocation object and inputs constructed; and an invocation request submitted to the queue.

The client thread reads the concurrency configurations and further spurs one or more invocation threads 638. Each invocation thread applies the invocation object and inputs, and invokes one or more times the designated Web service according to the concurrency configurations.

The present invention is a real time interactive system. Upon submission of the Web based form 348, the system manages the on-going Web Services invocation by pausing, stopping, or restarting the execution of invocation threads 638.

The invocation result 630 consisting of outputs and SOAP performance measures is saved in real time while the invocation threads are executing. The outputs are SOAP responses, if successfully invoked, or SOAP fault messages otherwise.

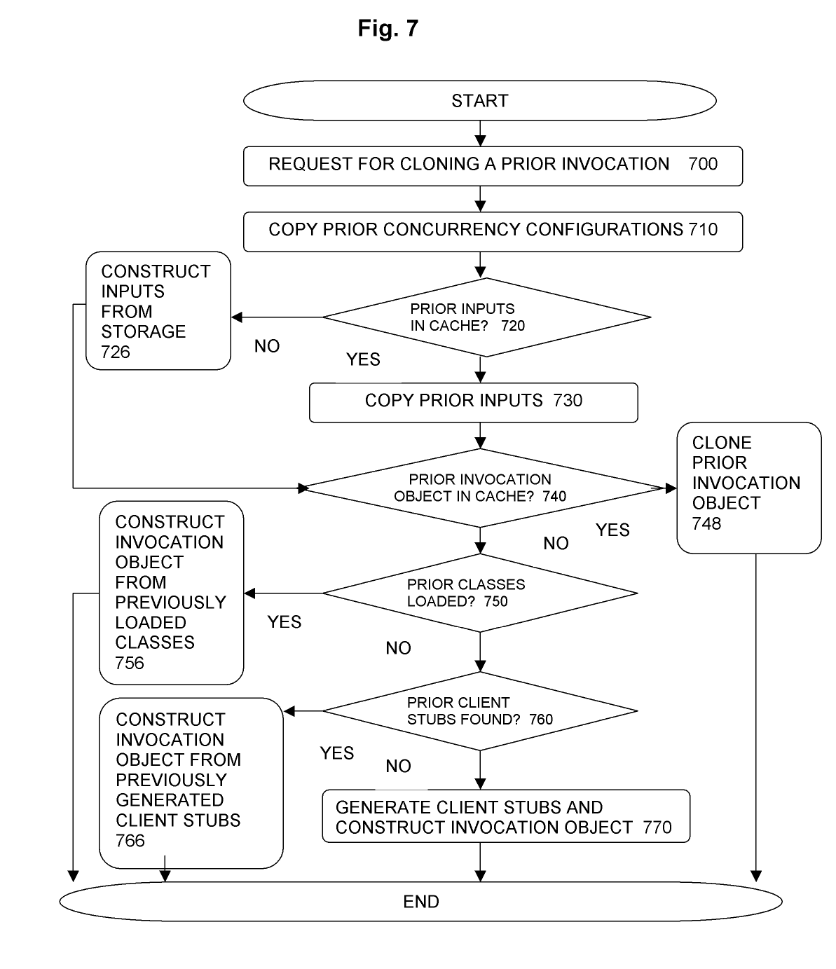

When end users want to invoke a previously invoked Web service with the same set of inputs and concurrency configurations, instead of once again filling out the Web based forms 200, 220, and 500, the system clones the prior Web Services invocation as depicted in FIG. 7.

As long as above-mentioned three prerequisites are copied over or reconstructed, the sequence of copying or reconstruction is not important. FIG. 7 is an illustration of one of the many possible sequences. The system straight-forwardly copies the concurrency configurations 710 upon receipt of the cloning request 700. Then, it looks up the inputs 720 from cache. It copies inputs 730 or reconstructs it in process 726.

Next, the system looks up the invocation object 740 in cache, and copies 748 over if it's found. Otherwise, the system takes following three routes similar to those in FIG. 4: 1. starting with WSDL, taking 740 750 760 770; 2. starting with the generated stubs, taking 740 750 760 766; 3. starting with the loaded classes, taking 740 750 756.

Again, the system uses the workflow in FIG. 6 to invoke the previously invoked Web service and manages the cloned invocation by pausing, stopping, or restarting the execution of invocation threads 638.

### Processing Invocation Results

The present invention uses the open source program Apache Axis to process SOAP calls. Axis handles the deserialization of XML content in SOAP responses into Java objects. The present invention processes the Java objects and automatically generates JSP pages to display the invocation results with no need to code the visual presentation. The system processes an invocation result by constructing a table from the Java object. Each row in the table is a name value pair. The visual presentation is performed by fitting the table into a set of predefined templates that allow end users to tailor the report to their preferences.

The following WSDL fragment indicates the invocation result for operation GetStockQuotes is of type ArrayOfQuote:

<s:element
name=“GetStockQuotesResponse”> <s:complexType> <s:s
equence> <s:element minOccurs=“0” maxOccurs=“1”
name=“GetStockQuotesResult” type=“s0:ArrayOfQuote” /
> </s:sequence> </s:complexType> </s:element>

The system retrieves quotes, say, for QQQ and SPY. Here is the SOAP response:

<?xml version=“1.0” encoding=“UTF-8”?><soap:Envelope
xmlns:soap=“http://schemas.xmlsoap.org/soap/envelope
/”
xmlns:xsi=“http://www.w3.org/2001/XMLSchema-instan
ce”
xmlns:xsd=“http://www.w3.org/2001/XMLSchema”><so
ap:Body><GetStockQuotesResponse
xmlns=“http://swanandmokashi.com/”><GetStockQuotes
Result><Quote><CompanyName>NASDAQ 100
TRUST</CompanyName><StockTicker>QQQ</StockTick
er><StockQuote>31.80</StockQuote><LastUpdated>4:
16pm</LastUpdated><Change>+0.38</Change><Open
Price>31.79</OpenPrice><DayHighPrice>32.33</DayHi
gh-
Price><DayLowPrice>31.52</DayLowPrice><Volume>85
739504</Volume><MarketCap>N/A</MarketCap><Yea
rRange>19.76 -
32.75</YearRange></Quote><Quote><CompanyName
>S&amp;amp;P DEPOS
RECPTS</CompanyName><StockTicker>SPY</StockTicke
r><StockQuote>99.39</StockQuote><LastUpdated>4:1
5pm</LastUpdated><Change>+0.23</Change><OpenP
rice>99.98</OpenPrice><DayHighPrice>100.94</DayHi
gh-
Price><DayLowPrice>99.05</DayLowPrice><Volume>59
123300</Volume><MarketCap>N/A</MarketCap><Yea
rRange>77.07 -
102.179</YearRange></Quote></GetStockQuotesResult
></GetStockQuotesResponse></soap:Body></soap:Enve
lope>

Apache Axis constructs from the SOAP response ajava object of type ArrayOfQuote and the system constructs a table as listed below from the Java object. And the predefined templates provide a visual format of the table.

Stock Quotes Constructed from the ArrayOfQuote Java Object

| CompanyName | NASDAQ 100 TRUST |
|---|---|
| StockTicker | QQQ |
| StockQuote | 31.80 |
| LastUpdated | 4:16pm |
| Change | +0.38 |
| OpenPrice | 31.79 |
| DayHighPrice | 32.33 |
| DayLowPrice | 31.52 |
| Volume | 85739504 |
| MarketCap | N/A |
| YearRange | 19.76-32.75 |
| CompanyName | S&P DEPOS RECPTS |
| StockTicker | SPY |
| StockQuote | 99.39 |
| LastUpdated | 4:15pm |
| Change | +0.23 |
| OpenPrice | 99.98 |
| DayHighPrice | 100.94 |
| DayLowPrice | 99.05 |
| Volume | 59123300 |
| MarketCap | N/A |
| YearRange | 77.07-102.179 |

By the way, the SOAP request message is listed below:

<?xml version=“1.0” encod-
ing=“UTF-8”?><soapenv:Envelope
xmlns:soapenv=“http://schemas.xmlsoap.org/soap/envel
ope/” xmlns:xsd=“http://www.w3.org/2001/XMLSchema”
xmlns:xsi=“http://www.w3.org/2001/XMLSchema-instan
ce”> <soapenv:Body> <GetStockQuotes
xmlns=“http://swanandmokashi.com/”>
<QuoteTicker>qqq,spy</QuoteTicker>
</GetStockQuotes>
</soapenv:Body></soapenv:Envelope>

In addition to presenting the invocation result as name value pairs, the present invention comprises of the computer program product to intercept and present raw SOAP request and response messages as listed above. This way, the computer program product has SOAP request messages transformed by end users, resent to the original SOAP endpoints, or a newly designated SOAP endpoints reconfigured in real time.

Apache Axis has a built-in TcpMon to do SOAP message transformation and redirection. It's a technology configured on the server side. The present invention is a client side technology innovation with no need to listen to any network communication ports. Also, TcpMon is ajava Swing program while the present invention is a Web based computer program product.

In case the SOAP response message carries attachments, the system first saves the attachments for each end user and categorizes the attachments by Web Services port name, then removes the attachments from system cache. In case of multi-threaded invocations, the system reconstructs the invocation object after each removal of the attachments from system cache.

The present invention is a system, method, and computer program product to take SOAP performance measures while invoking Web Services and processing SOAP responses. The system measures three parameters:
1. SOAP throughput. It is the number of completed invocations in a given period of time, wherein a completed invocation is a SOAP request/response round trip. Each invocation request causes a client thread to be spurred, which in turn spurs one or more invocation threads according to the concurrency configurations. And each invocation thread performs one or more invocations as per the concurrency configurations. Therefore, SOAP throughput is a measurement for multiple transactions/invocations with multiple threads/virtual users. SOAP throughput measures the speed of the Web Services invoker and is an indicator in the Web Services performance testing.
2. Active Invocation Threads. It is the number of virtual users that are in the process of invoking Web Services. The computer program product samples the data at a certain time interval and comes up an indication of the client load. The number of active invocation threads is an indicator in the Web Services load testing.
3. Memory Usage. The computer program code measures the memory map in the heap allocation of the Java virtual machine and comes up with an indicator of how much memory is used by the virtual users/active invocation threads. Memory usage is an indicator in the Web Services performance testing.

The system uses all of the above-mentioned three parameters in benchmark testing Web Services, which consists of: 1. saving an invocation request as the baseline, and comparing performance and load of other invocation requests to the baseline; 2. saving at least two invocation requests as benchmarks, and comparing performance and load among the benchmarks.

The computer program product generates JSP pages and allows end users to configure and reconfigure baseline and benchmark comparisons in real time.

The computer program product computes SOAP throughput by taking reciprocal of the moving average of SOAP response time. Meanwhile, the computer program product collects statistics of SOAP response time in real time: minimum response time, maximum response time, and mean response time.

The computer program product measures and displays the real time progress of Web Services invocations. The progress measurement has three indicators: percentage success, percentage fail, and percentage unfinished, which sums up to one hundred percent. The computer program product also measures and displays the elapsed time, and estimates time to completion.

### The Overloaded Methods

Overloaded methods are methods of the same names but different method signatures. Method itself is a concept in object-oriented programming. In WSDL, the correspondent term is operation. Overloaded methods in WSDL are described as operations of the same name but different input/output parameters. There is a constant need to distinguish between overloaded methods from parsing WSDL to constructing invocation inputs. The challenge is that method name is presented in the Web based forms and the backend has to maintain and track the mapping between method names and the method objects. When methods are overloaded, the same method name can be mapped to different method objects.

The present invention provides a computer program product to process overloaded methods: 1. Overloaded methods in parsing WSDL 328 in FIG. 3. First, constructing operation objects from WSDL. Second, for each operation object, constructing a list of parameter types. Third, constructing a method table to map between the operation object and parameter type list; 2. Overloaded methods in constructing invocation inputs. First, listing method names in the Web based form 348 in FIG. 3. Second, associate each method name to an index that points to the position in the method table. Third, read the parameter type list from the method table. Fourth, constructing invocation inputs with the form data and the parameter type lists 500, 510, 520, 530 in FIG. 5.

### The Finance Schedules

The present invention provides two finance schedules for end users to use the system to invoke Web Services:
1.Pay-as-you-go Schedule. When receiving new WSDL and concurrency configurations, the system presents a Web based form and demands payment for the invocation service to be provided. The payment method is credit card, debit card, or check. The system processes the form data and seeks authorization of payment in real time. The system will not proceed to invoking the designated Web service until the payment authorization is successful.
2.Prepaid Schedule. When receiving new WSDL and concurrency configurations, the system charges the end user out of the subscription plan where the end user has prepaid for the rights to use the system to invoke Web Services. The subscription plan carries a term limit and a virtual user limit.

The system is free of charge when the end user is of visitor status. The number of invocation thread, however, is limited to one for free invocation.

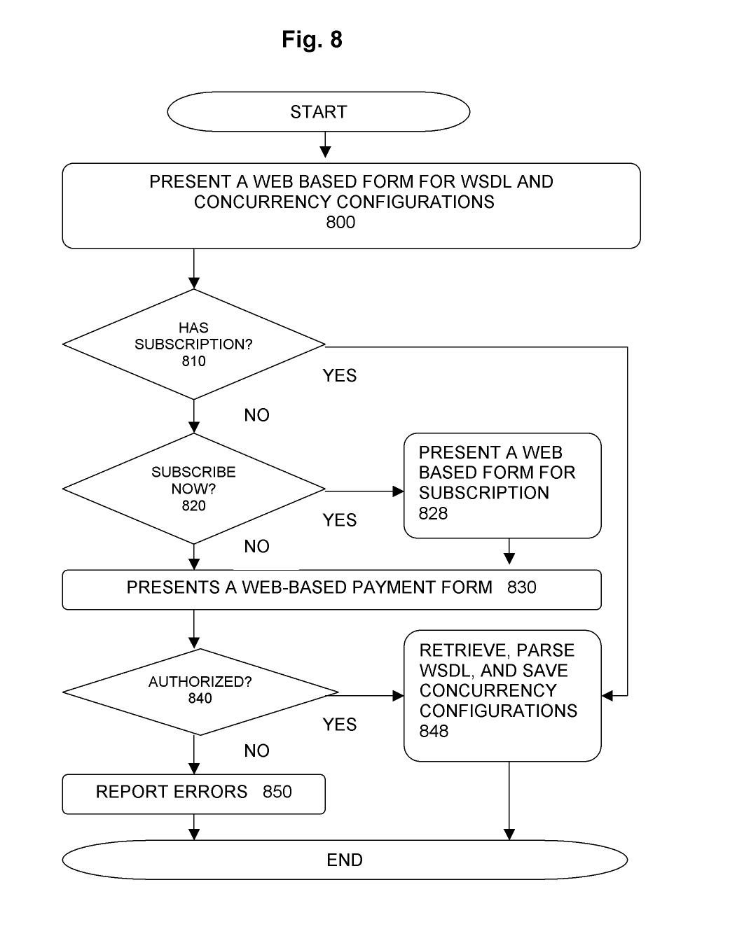

So far, the finance schedules are omitted in drawings for simplicity. A close look at FIG. 2 gives an insertion point of the finance schedules between processes 200, 210, and 218. Drilling down to the insertion point leads to FIG. 8 where the system starts from processing form data 800 and ends with processing WSDL and saving concurrency configurations 848. The finance schedules are depicted in the middle.

When receiving new WSDL and concurrency configurations, the system first checks whether the end user has a subscription plan 810 to cover the Web Services invocation. If true, the system proceeds to process 848 directly. Otherwise, the system prompts the end user to subscribe the invocation service 820. If the end user chooses to subscribe, the system presents a Web based subscription form 828. The system presents a Web based payment form 830 whether the end user chooses to subscribe or not, as long as the system does not find a sufficient subscription plan to cover the Web Services invocation. The system processes payment form data and seeks a third party authorization 840 for the payment. The system proceeds to the next stage of processing WSDL and saving concurrency configurations 848 if the authorization is successful, and reports errors otherwise.

The pay-as-you-go finance schedule is embodied in the route of 800 810 820 830 840 848. The prepaid finance schedule is embodied in two routes: 800 810 848, and 800 810 820 828 830 840 848. Both finance schedules charge on the basis of virtual users/number of invocation threads. The Web based payment form 830, however, has different pricing for the two finance schedules. As the prepaid schedule also carries a term limit, pricing for the prepaid schedule is based on the duration of the subscription and virtual users as well.

### The Invocation Form

The Web based form depicted in boxes 220, 348, and 500 is an invocation form that allows end users to dynamically configure and reconfigure the list of operations to be invoked and to enter parameter values for each operation. The computer program product renders the invocation form in HTML with JSP.

The invocation form presents two lists of operations. One is the full list of operations included in the Web service.

The other is the list of operations selected by end users for invoking the Web service. The second list is an invocation list and is a sub set of the first. The dynamically configured membership and the sequence in the invocation list dictate what operations are to be invoked and what the invocation sequence is.

When end users submit the invocation list along with the parameter values, they inadvertently double click the submit button and cause the invocation form to be submitted twice, which causes waste of network bandwidth and computer cycles in the backend. The present invention provides means for detecting and ignoring duplicate form submissions by monitoring an order submission stack. Membership in the order stack indicates a duplicate submission, which is ignored unless it is a resend of a previously failed invocation.

The computer program product treats each new submission of WSDL 200 as a new order and saves concurrency configurations in the order object. The invocation form submission causes the concurrency configurations data to be transformed to the invocation request object and the order object to be persisted in the backend database.

1. A method of consuming Web Services on demand, comprising steps of: parsing WSDL files; automatically generating Web Services client stubs; invoking Web Services with multiple threads; and processing invocation results.

2. The method according to claim 1, wherein the WSDL parsing step causes Web-based forms to be generated concurrently with the client stubs.

3. The method according to claim 1, wherein the Web Services invoking step further comprises steps of: optimally constructing invocation objects; recursively constructing invocation inputs; setting concurrency configurations; and making SOAP calls.

4. The method according to claim 3, wherein the invocation object construction step further comprises the step of automatically constructing invocation objects from said WSDL files.

5. The method according to claim 3, wherein the invocation object construction step further comprises the step of automatically constructing invocation objects from said client stub.

6. The method according to claim 3, wherein the invocation object construction step further comprises the step of automatically constructing invocation objects from loaded classes.

7. The method according to claim 3, wherein the input construction step further comprises the step of recursively mapping SOAP schema types to data types of the underlying programming language.

8. The method according to claim 3, wherein the concurrency configuration step further comprises the steps of: setting total number of invocation threads; setting initial number of invocation threads; setting time interval for the next thread after initial threads have been spurred; and setting number of repeated invocations per invocation thread.

9. The method according to claim 3, further comprising the step of constructing invocation requests from: said invocation objects; said invocation inputs; and said concurrency configurations.

10. The method according to claim 3, wherein the SOAP call step further comprises the step of simultaneously processing one or more said invocation requests.

11. The method according to claim 10, wherein each invocation request causes one or more invocation threads to be spurred.

12. The method according to claim 1, wherein the Web Services invoking step further comprises the steps of: pausing said invocation threads; stopping said invocation threads; and restarting paused invocation threads.

13. The method according to claim 1, wherein the Web Services invoking step further comprises the step of cloning prior Web Services invocations.

14. The method according to claim 1, further comprising the steps of: measuring SOAP throughput, which indicates the number of completed invocations in a given period of time; measuring active invocation threads; measuring memory usage of the invocation threads; saving an invocation request as the baseline, and comparing performance and load of other invocation requests to the baseline; saving at least two invocation requests as benchmarks, and comparing performance and load among the benchmarks.

15. The method according to claim 1, further comprising the step of charging end users with a pay-as-you-go finance schedule.

16. The method according to claim 1, further comprising the step of charging end users with a prepaid finance schedule.

17. The method according to claim 1, wherein the result processing step further comprises the step of presenting the invocation result with a set of predefined templates.

18. The method according to claim 1, wherein the result processing step further comprises the step of processing attachments which are received along with the invocation results.

19. A system for consuming Web Services on demand, comprising means for: parsing WSDL files; automatically generating Web Services client stubs; invoking Web Services with multiple threads; and processing invocation results.

20. The system according to claim 19, further comprising means for processing instantaneous and spontaneous invocation requests.

21. The system according to claim 19, further comprising means for dynamically configuring and reconfiguring the invocation requests.

22. The system according to claim 19, wherein the means for invoking Web Services further comprises means for charging end users with a pay-as-you-go finance schedule.

23. The system according to claim 19, wherein the means for invoking Web Services further comprises means for charging end users with a prepaid finance schedule.

26. The system according to claim 19, further comprising means for instantly making Web Services accessible via the Web.

25. The system according to claim 19, further comprising means for: performance testing Web Services; load testing Web Services; and benchmark testing Web Services.

26. A computer program product for consuming Web Services on demand, the computer program product embodied on one or more computer-readable media and comprising computer-readable program code means for: parsing WSDL files; automatically generating Web Services client stubs; invoking Web Services with multiple threads; and processing invocation results.

27. The computer program product according to claim 26, wherein the means for parsing WSDL files causes HTML forms to be generated concurrently with Java client stubs.

28. The computer program product according to claim 26, wherein the means for invoking Web Services further comprises computer-readable program code means for:
optimally constructing invocation objects; recursively constructing invocation inputs; setting concurrency configurations; and making SOAP calls.

29. The computer program product according to claim 28, wherein the means for constructing invocation objects further comprises computer-readable program code means for automatically constructing invocation objects from said WSDL files.

30. The computer program product according to claim 28, wherein the means for constructing invocation objects further comprises computer-readable program code means for automatically constructing invocation objects from said client stubs.

31. The computer program product according to claim 28, wherein the means for constructing invocation objects further comprises computer-readable program code means for automatically constructing invocation objects from loaded classes.

32. The computer program product according to claim 28, wherein the means for constructing inputs further comprises computer-readable program code means for recursively mapping SOAP schema types to Java types.

33. The computer program product according to claim 28, wherein the means for concurrency configurations further comprises computer-readable program code means for: setting total number of invocation threads; setting initial number of invocation threads; setting time interval for the next thread after initial threads have been spurred; and setting number of repeated invocations per invocation thread.

34. The computer program product according to claim 28, further comprising computer-readable program code means for constructing invocation requests from: said invocation objects; said invocation inputs; and said concurrency configurations.

35. The computer program product according to claim 28, wherein the means for making SOAP calls further comprises computer-readable program code means for simultaneously processing one or more said invocation requests.

36. The computer program product according to claim 35, wherein each invocation request causes one or more invocation threads to be spurred.

37. The computer program product according to claim 26, wherein the means for invoking Web Services further comprises computer-readable program code means for: pausing said invocation threads; stopping said invocation threads; and restarting paused invocation threads.

38. The computer program product according to claim 26, wherein the means for invoking Web Services further comprises computer-readable program code means for cloning prior Web Services invocations.

39. The computer program product according to claim 26, further comprising computer-readable program code means for: measuring SOAP throughput, which indicates the number of completed invocations in a given period of time; measuring active invocation threads; measuring memory usage of the invocation threads; saving an invocation request as the baseline, and comparing performance and load of other invocation requests to the baseline; saving at least two invocation requests as benchmarks, and comparing performance and load among the benchmarks.

40. The computer program product according to claim 26, further comprising computer-readable program code means for: measuring minimum response time for Web Services invocations; measuring maximum response time for Web Services invocations; measuring mean response time for Web Services invocations; measuring percentage success for Web Services invocations; measuring percentage fail for Web Services invocations; measuring percentage unfinished for Web Services invocations; measuring elapsed time for Web Services invocations; and estimating time to completion for Web Services invocations.

41. The computer program product according to claim 26, wherein the means for invoking Web Services further comprises computer-readable program code means for charging end users with a pay-as-you-go finance schedule.

42. The computer program product according to claim 26, wherein the means for invoking Web Services further comprises computer-readable program code means for charging end users with a prepaid finance schedule.

43. The computer program product according to claim 26, wherein the means for processing invocation results further comprises computer-readable program code means for presenting the invocation result as a table of name value pairs.

44. The computer program product according to claim 26, wherein the means for processing invocation results further comprises computer-readable program code means for processing attachments which are received along with the invocation results.

45. The computer program product according to claim 26, further comprising computer-readable program code means for processing overloaded methods.

46. The computer program product according to claim 26, further comprising computer-readable program code means for: intercepting SOAP request messages; intercepting SOAP response messages; transforming SOAP request messages; and redirecting SOAP request messages.

47. The computer program product according to claim 25, wherein the means for generating HTML forms further comprises computer-readable program code means for dynamically reconfiguring the list of operations to be invoked.

48. The computer program product according to claim 25, further comprises computer-readable program code means for ignoring duplicate submissions of the generated HTML forms.
